(19) United States
(12) Patent Application Publication
(10) Pub. No.: US 2026/0360590 A1
(43) Pub. Date: Nov. 12, 2026

(54) SYSTEM AND A DEVICE FOR FACILITATING SUPERCONDUCTING ACTIVITIES USING PIPE LIKE STRUCTURES

(71) Applicant: Francisco J Castillo Sotillo, Hutchinson, KS (US)

(72) Inventor: Francisco J Castillo Sotillo, Hutchinson, KS (US)

(21) Appl. No.: 19/204,815

(22) Filed: May 12, 2025

(51) Int. Cl. H01B 12/02

(52) U.S. Cl. CPC H01B 12/02

(57) ABSTRACT

A device for facilitating superconducting activities. The device includes a superconducting device composed of 50% Lithium gas, and a 20/80 Neon-Argon gas mixture that occupies the other 50% of the total volume of a cavity. The device includes a hermetic cavity to prevent the Lithium gas from being in contact with air providing the Lithium gas with an inert atmosphere of the Neon-Argon gas mixture that would correspond to the remaining 50% of the total volume of the internal cavity of the superconducting device.

### CROSS-REFERENCES TO RELATED APPLICATIONS

N/A.

### FIELD OF THE TECHNOLOGY

The present disclosure generally relates to a superconducting device that is composed of 50% lithium and 50% of a blend of proportion 20/80 neon-argon gas mixture and more specifically, to lithium and neon/argon is place inside a hermetic cavity (where Lithium has the appropriate operating conditions under ambient conditions) (to prevent the lithium from contacting the air.)

### DESCRIPTION OF THE RELATED ART

(due to its high reactivity) (Traditionally), lithium must be in an inert atmosphere. The inert gas mixture used can be difficult to obtain, (Because it is a specific proportion that was mixed in order to make this superconductor) Materials that do not react with lithium must be used. The device must be hermetically sealed for the device to be functional and safe.

Further, research has been done in search of superconductors by combining different elements of the periodic table, especially metals, rare earths and any other element that contributes to generating a layered structure of superconductivity at the highest possible temperature.

What is needed is a system and a device for facilitating superconducting activities that use a mixture of noble gases to provide the metal (i.e. Lithium) with an inert environment, where the focus is not on (reduce the) temperature, but rather on changing the atmosphere that surrounds the metal and thus experiencing its superconducting qualities at room temperature.

### SUMMARY

In an embodiment, a system for facilitating superconducting activities. The system includes a superconducting device composed of 50% Lithium gas, and a (20/80) Neon-Argon gas mixture (at 20/80 concentration respectively) that occupies the other 50% of the total volume of a cavity. The system includes a hermetic cavity to prevent the Lithium gas from being in contact with air providing the Lithium gas with an inert atmosphere of the Neon-Argon gas mixture that would correspond to the remaining 50% of the total volume of the internal cavity of the superconducting device.

In another embodiment, a device for facilitating superconducting activities. The device includes a superconducting device composed of 50% Lithium gas, and a 20/80 Neon-Argon gas mixture that occupies the other 50% of the total volume of a cavity. The device includes a hermetic cavity to prevent the Lithium gas from being in contact with air providing the Lithium gas with an inert atmosphere of the Neon-Argon gas mixture that would correspond to the remaining 50% of the total volume of the internal cavity of the superconducting device.

In still another embodiment, a superconducting device is provided. The superconducting device is composed of 50% Lithium gas, and a 20/80 Neon-Argon gas mixture that occupies the other 50% of the total volume of a cavity. The superconducting device includes a hermetic cavity to prevent the Lithium gas from being in contact with air providing the Lithium gas with an inert atmosphere of the Neon-Argon gas mixture that would correspond to the remaining 50% of the total volume of the internal cavity of the superconducting device.

### BRIEF DESCRIPTION OF THE DRAWINGS

The present invention is described in detail below with reference to the attached drawing figures, which are incorporated by reference herein and wherein:

FIG. 1 is a block diagram illustrating an exemplary embodiment of the invention;

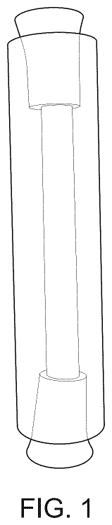

FIG. 2 is a block diagram in accordance with another exemplary embodiment of the invention;

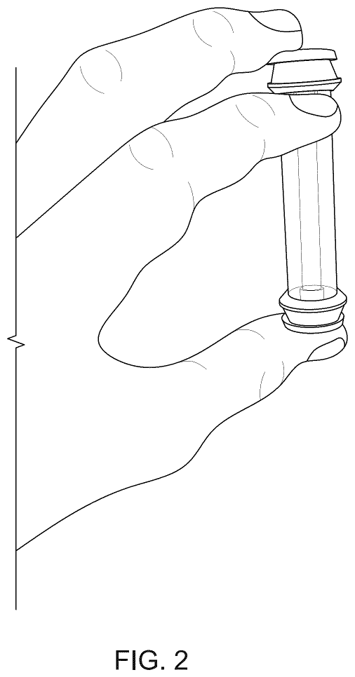

FIG. 3 is a system block diagram with a vehicle in accordance with another exemplary embodiment of the invention; and

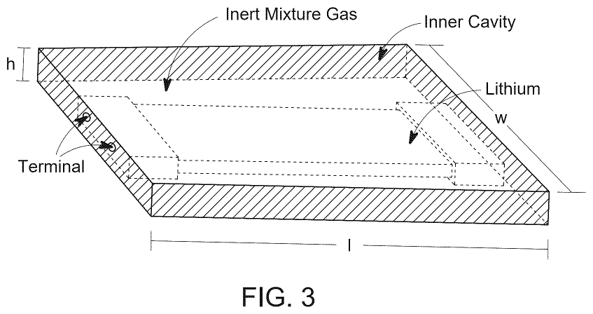

FIG. 4 is a block diagram in accordance with another exemplary embodiment of the invention; and

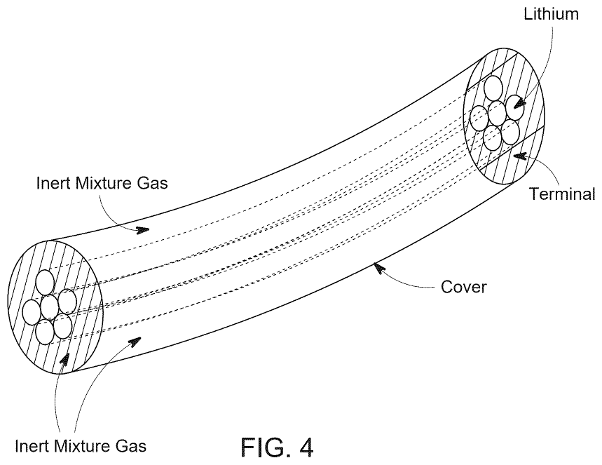

FIG. 5 is a diagram of an exemplary embodiment of the invention.

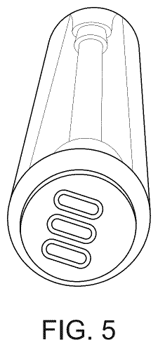

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

In an embodiment, the present invention includes a superconducting device composed of 50% Lithium, and a 20/80 Neon-Argon gas mixture that occupies the other 50% of the total volume of the cavity. These elements include a hermetic cavity to prevent the Lithium from being in contact with air providing the Lithium with an inert atmosphere of Neon-Argon gas that would correspond to the remaining 50% of the total volume of the internal cavity of the device. This device may work variety of ornamental (exterior) designs and can take any shape from a cable to larger equipment or devices.

In some embodiments, the device works at room temperature, which is highly relevant, since other superconducting materials are currently only available at (room temperature) (temperatures well below ambient, as cold as the) Liquid nitrogen (−321 °F) which is a very low temperature; thus limiting most of its industrial uses. From a configuration of Lithium, Argon and Neon, a system is created that constitutes a superconducting device, making the (·) Lithium shows qualities of a Superconductor at room temperature (68 °F), without the need now to bring the study material (Lithium) to the temperature of liquid nitrogen. This device would reduce heat losses to zero or close to zero, due to having an electrical resistivity of zero or close to zero.

In other embodiments, minimizing heating of devices that operate with electricity, making electronic or electronic devices more efficient. It would also reduce energy consumption and operating expenses of the equipment. And no less important is the ability to repel the lines of magnetic flux inside it, turning it into a diamagnetic device, which results in high impact effects such as the levitation of the magnet that is placed on it, and all the applications in the daily life that this can entail.

In another embodiment, the present invention includes methods, apparatuses, devices, and systems for creating, controlling, conducting, and optimizing fusion activities of nuclei. The controlled fusion activities cover a spectrum of reactions from aneutronic, fusion reactions that produce essentially no neutrons, to neutronic, fusion reactions that produce substantial numbers of neutrons.

In yet another embodiment, the present invention includes a superconductive device containing a rotor that can be rotated about an axis of rotation and that comprises a superconductive winding in a winding support. Said winding support has a central cavity, into which two fixed thermal tubes project axially. One of said tubes forms a cooling finger that is closed at the end and contains a second coolant with a higher condensation temperature. The other tube supplies a first cooling with a lower condensation temperature to the central cavity and evacuates said coolant from the cavity. To condense the coolants, the tubes lead to a refrigeration unit, situated outside the rotor and equipped with a refrigeration head and a condenser device.

In still another embodiment, the present invention includes a thermally insulated double pipe, a structure is provided in which an inner pipe may be prevented from being appreciably off set relative to an outer pipe due to thermal contraction. The structure includes an inner pipe, within which a superconducting cable is mounted, an outer pipe within which the inner pipe is housed, with the inner and outer pipes constituting a thermally insulated double pipe, and an inner pipe support member supporting the inner pipe. The inner pipe support member is secured to the inner and outer pipes.

In another embodiment, the present invention includes a superconducting power transmission system that comprises an inner pipe housing a superconducting cable therein, a radiation covering at least a part of the inner pipe from outside; and an outer pipe housing the inner pipe and the radiation shield therein. A vacuum is created in a space from an inside of the outer pipe to an outside of the inner pipe with the radiation shield therebetween. The system further comprises at least one radiation shield pipe, housed in the outer pipe and thermally coupled with the radiation shield, a liquified natural gas (LNG) as a second cryogen for the radiation shield being made to flow through the radiation shield pipe.

Many different arrangements of the various components depicted, as well as components not shown, are possible without departing from the spirit and scope of the present invention. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A system for facilitating superconducting activities comprising:
a superconducting device composed of 50% Lithium gas, and a 20/80 Neon-Argon gas mixture that occupies the other 50% of the total volume of a cavity, wherein the superconducting device includes a hermetic cavity to prevent the Lithium gas from being in contact with air providing the Lithium gas with an inert atmosphere of the Neon-Argon gas mixture that would correspond to the remaining 50% of the total volume of the internal cavity of the superconducting device.

2. The system of claim 1, wherein the device may work with a variety of ornamental designs and can take any shape from a cable to larger equipment or devices.

3. The system of claim 1, wherein the device works at room temperature.

4. The system of claim 1, wherein the device works at −321 °F degrees.

5. The system of claim 1, wherein the device works at 68 °F degrees.

6. The system of claim 1, wherein the device minimizes heating of devices that operate with electricity.

7. The system of claim 6, wherein the device reduces energy consumption and operating expenses of the equipment.

8. A device for facilitating superconducting activities comprising:
a superconducting device composed of 50% Lithium gas, and a 20/80 Neon-Argon gas mixture that occupies the other 50% of the total volume of a cavity, wherein the superconducting device includes a hermetic cavity to prevent the Lithium gas from being in contact with air providing the Lithium gas with an inert atmosphere of the Neon-Argon gas mixture that would correspond to the remaining 50% of the total volume of the internal cavity of the superconducting device.

9. The device of claim 8, wherein the device may work with a variety of ornamental designs and can take any shape from a cable to larger equipment or devices.

10. The device of claim 8, wherein the device works at room temperature.

11. The device of claim 8, wherein the device works at −321 °F degrees.

12. The device of claim 8, wherein the device works at 68 °F degrees.

13. The device of claim 8, wherein the device minimizes heating of devices that operate with electricity.

14. The device of claim 8, wherein the device reduces energy consumption and operating expenses of the equipment.
